(19) United States
(12) Patent Application Publication
(10) Pub. No.: US 2004/0015644 A1
(43) Pub. Date: Jan. 22, 2004

(54) Cache memory and method for addressing

(76) Inventors: Berndt Gammel, Markt Schwaben (DE); Thomas Kunemund, Munchen (DE)

Correspondence Address: LERNER AND GREENBERG, P.A., POST OFFICE BOX 2480, HOLLYWOOD, FL, 33022-2480, US

(21) Appl. No.: 10/619,979

(22) Filed: Jul. 15, 2003

Related U.S. Application Data
(63) Continuation of application No. PCT/DE01/04821, filed on Dec. 20, 2001.

(30) Foreign Application Priority Data
Jan. 15, 2001 (DE) 101 01 552.6

(51) Int. Cl. G06F 12/08

(52) U.S. Cl. 711/3; 711/202; 711/163

(57) ABSTRACT

In a cache memory whose addresses are split into tag, index and offset parts, a transformation device is provided in hardware form for performing a transformation between a respective tag part of the address and a coded tag address that is unambiguous in both directions. In addition, the index field of the addresses of the cache memory can be encoded by another mapping procedure that maps the index field onto a coded index field and is unambiguous in both directions. A hardware unit of suitable configuration is also used for this purpose.

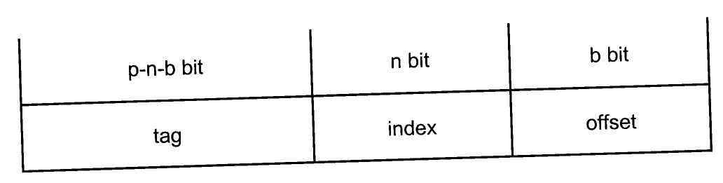

### CROSS-REFERENCE TO RELATED APPLICATION

This application is a continuation of copending International Application PCT/DE01/04821, filed Dec. 20, 2001, which designated the United States and which was not published in English.

### BACKGROUND OF THE INVENTION

1. Field of the Invention

The invention relates to a cache memory used in a security controller.

Cache memories are generally relatively small but fast buffer memories that are used for reducing the latency of processor access to slow external memories. The cache memory effectively covers selected address areas of the external memory, and contains both temporarily modified data and information associated with it, such as information for locating the data. The article by Alan Jay Smith titled “Cache Memories” in Computing Surveys, Vol. 14, No.3, September 1982, pages 473-530, provides an overview of cache memories. Hardware-implemented cache memories can be characterized in general as N-way set-associative memory arrays. The extreme cases are given by N=1, representing a direct mapped memory, and N=M, representing a fully associative cache memory, where M is the total number of entries in the memory.

In general the data is saved in blocks of 2^{b} bytes per memory entry. In the general case of a set-associative cache memory with N=2ⁿ ways, a p-bit wide address of the item of data is normally split into n bits for the index, b bits for the offset and the remaining p-n-b bits for the tag. This is illustrated in the attached figure.

When accessing an item of data in the cache memory, e.g. in a read or write process, the index field is used to address a set directly. The tag field is saved with the respective block in order to identify it uniquely within a set. In an associative search for the block, the tag field of the address is compared with the tag fields of the selected set in order to locate the relevant block. The offset entry is used in order to address the item of data within the block.

In Published, Non-Prosecuted German Patent Application DE 199 57 810 A1, a scatter-mapping method is described for a cache-memory device. In the method, significant bits that are added to the tag address are used to assign the tag addresses to different areas of the memory by use of a tag mapping table.

By this method it is possible to select different memory areas whose contents can be transferred to the cache memory, without needing to extend the tag address itself.

Cache memories of this kind represent easily identifiable regular structures in security controllers. In addition to bus lines and registers, the cache memories therefore constitute preferred physical targets for unauthorized scrutiny or manipulation of security-related data, e.g. by needle attacks or the like. In external memories, security-critical data is normally protected by a hard-to-crack code, which may be implemented as hardware for instance. Even for a hardware-implemented solution, the hard encoding and decoding process using relevant algorithms introduces high latency into the memory operation, which is added to the latency of the memory itself and may well be the predominant factor. This kind of encoding is unsuitable for cache memories, which are typically supposed to allow access in one or at most a very few clock cycles. Cache memories therefore constitute a weak point in the security design of this type of security controller unless other protection is provided.

### SUMMARY OF THE INVENTION

It is accordingly an object of the invention to provide a cache memory and a method for addressing that overcome the above-mentioned disadvantages of the prior art devices and methods of this general type, which defines a facility for effective and practical protection of a cache memory in a security controller.

With the foregoing and other objects in view there is provided, in accordance with the invention, a cache memory. The cache memory contains addresses split into a tag part, an index part and an offset part. Means are provided for performing a transformation between the tag part of an address and a coded tag address that is unambiguous in both directions.

In addition, the means may perform a transformation between the index part of the address and a coded index address that is unambiguous in both directions.

With the foregoing and other objects in view there is provided, in accordance with the invention, a method for addressing a cache memory. The method includes the step of performing a transformation between a tag part of a cache address and a coded tag address that is unambiguous in both directions.

In accordance with a further mode of the invention, there is the step of performing a transformation between an index part of the cache address and a coded index address that is unambiguous in both directions.

Other features which are considered as characteristic for the invention are set forth in the appended claims.

Although the invention is described herein as embodied in a cache memory and a method for addressing, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### BRIEF DESCRIPTION OF THE DRAWINGS

The single FIGURE of the drawing is an illustration of a p-bit wide address setup for a cache memory.

### DESCRIPTION OF THE PREFERRED EMBODIMENTS

In a cache memory according to the invention, means are provided for performing a transformation between the respective tag part of the address and a coded tag address that is explicit in both directions. The means preferably exist in hardware. The addressing method according to the invention applies a transformation between a tag part of a cache address and a coded tag address that is explicit in both directions, and which is preferably performed using dedicated hardware.

The solution according to the invention specifies the means and procedure of a method that can be used to increase the security level of items of data and their addresses in cache memories without increasing the access time, or at most increasing it only marginally.

In set-associative cache memories, as described in the introduction, data is saved and retrieved using an index field and a tag field. According to the invention, mapping that is explicit in both directions (one-to-one mapping) is used to map the tag field of the address onto a coded tag field and vice versa. Blocks are then saved in the cache memory with the coded tag field. Efficient protection of the data block address information is provided by the means. The reversibly explicit mapping is performed here by a dedicated hardware unit. In preferred embodiments this is designed so that the transformation can be performed within one clock cycle, i.e. on the fly, which results in that the cache memory access time is not increased.

In a further embodiment of the invention, the index field of the cache memory addresses can also be encoded using another mapping procedure that maps the index field onto a coded index field and is explicit in both directions. Once again, a hardware unit of suitable design is used. This performs so-called set scrambling, where the block to be handled in the cache memory is saved in a set that cannot be found by trivial means. This extra form of encoding is preferably implemented if the processor architecture is not configured for unaligned data access, where data extends across block boundaries.

An embodiment of a cache memory according to the invention is particularly preferred in cache memories in security controllers.

We claim:

1. A cache memory, comprising:
addresses split into a tag part, an index part and an offset part; and
means for performing a transformation between the tag part of an address and a coded tag address being unambiguous in both directions.

2. The cache memory according to claim 1, wherein said means performs a transformation between the index part of the address and a coded index address that is unambiguous in both directions.

3. A method for addressing a cache memory, which comprises the step of:
performing a transformation between a tag part of a cache address and a coded tag address being unambiguous in both directions.

4. The method according to claim 3, which further comprises performing a transformation between an index part of the cache address and a coded index address being unambiguous in both directions.

5. A cache memory, comprising:
addresses split into a tag part, an index part and an offset part; and
a transformation device performing a transformation between the tag part of an address and a coded tag address being unambiguous in both directions.

6. The cache memory according to claim 5, wherein said transformation device performs a transformation between the index part of the address and a coded index address that is unambiguous in both directions.
